(19) United States
(12) Patent Application Publication
(10) Pub. No.: US 2017/0345397 A1
(43) Pub. Date: Nov. 30, 2017

(54) INFORMATION PROCESSING DEVICE AND IMAGE DISPLAY METHOD

(71) Applicant: LENOVO (SINGAPORE) PTE. LTD., Singapore (SG)

(72) Inventors: Yasumichi Tsukamoto, Yamato-shi (JP); Yuichi Shigematsu, Sagamihara-shi (JP)

(73) Assignee: LENOVO (SINGAPORE) PTE. LTD., Singapore (SG)

(21) Appl. No.: 15/254,468

(22) Filed: Sep. 1, 2016

(30) Foreign Application Priority Data
May 27, 2016 (JP) 2016-106393

(51) Int. Cl. G09G 5/14; G06F 3/0484; G06F 1/16; G06F 3/0482; G06F 3/0488; G09G 3/3208; G06F 3/044

(52) U.S. Cl. CPC G09G 5/14; G06F 1/162; G06F 3/04845; G06F 1/1618; G06F 3/044; G06F 1/1654; G06F 3/0488; G09G 3/3208; G06F 3/0482

(57) ABSTRACT

A flexible display device includes a first image display region and a second image display region having predetermined positions and sizes. In a case where a positional relationship between the first image display region and the second image display region changes to a tent mode, a cross border task bar is displayed on the first image display region. The cross border task bar is a graphical user interface for enabling a user to operate on an object displayed on the second image display region. The cross border task bar includes a tunnel window to which an object displayed on the first image display region can be dragged. The object dragged to the tunnel window is then displayed on the second image display region.

### FIELD OF THE INVENTION

The present invention relates to an information processing device and an image display method.

### BACKGROUND OF THE INVENTION

It is anticipated that a presenter and an audience, for example, face each other using an information processing device including an image display section with two display regions so that the presenter gives a presentation.

In such a case, an information processing device is used in such a manner that one of the display regions faces the presenter and the other display region faces the audience, for example. The presenter gives a presentation by displaying an object such as an image on the display region facing the audience.

### SUMMARY OF THE INVENTION

In a case where one display region faces the presenter and the other display region faces the audience, it is difficult for the presenter to correctly know a display state of the display region facing the audience. In addition, there is no technique that enables the presenter to easily operate the display state of an object on the display region facing the audience.

It is therefore an object of the present invention to provide an information processing device and an image display method that enables a user to easily operate an object displayed on a display region that is difficult to be visually recognized by the user.

According to a first aspect of the present invention, an information processing device includes: a first image display region; a second image display region; a determination unit that determines that a positional relationship between the first image display region and the second image display region changes to a predetermined positional relationship; and an image display control unit that displays, on the first image display region, a graphical user interface for enabling a user to operate an object displayed on the second image display region, in a case where the determination unit determines that the positional relationship between the first image display region and the second image display region changes to the predetermined positional relationship.

According to a second aspect of the present invention, an image display method of an information processing device including a first image display region and a second image display region, includes: determining that a positional relationship between the first image display region and the second image display region changes to a predetermined positional relationship; and displaying, on the first image display region, a graphical user interface for enabling a user to operate an object displayed on the second image display region, in a case where it is determined that the positional relationship between the first image display region and the second image display region changes to the predetermined positional relationship.

According to a third aspect of the present invention, a program causes a computer provided in an information processing device including a first image display region and a second image display region to function as: a determination unit that determines that a positional relationship between the first image display region and the second image display region changes to a predetermined positional relationship; and an image display control unit that displays, on the first image display region, a graphical user interface for enabling a user to operate an object displayed on the second image display region, in a case where the determination unit determines that the positional relationship between the first image display region and the second image display region changes to the predetermined positional relationship.

The present invention can provide an advantage that a user can easily operate an object displayed on a display region that is difficult to be visually recognized by the user.

### BRIEF DESCRIPTION OF THE DRAWINGS

FIG. 1 is an outline view schematically illustrating a flexible display device according to a first embodiment of the present invention.

FIG. 2 is an outline view schematically illustrating the flexible display device according to the first embodiment of the present invention in a tent mode.

FIG. 3 is a block diagram illustrating an electrical configuration of the flexible display device according to the first embodiment of the present invention.

FIG. 4 is a functional block diagram concerning a screen display operating function according to the first embodiment of the present invention.

FIG. 5 is a view illustrating a cross border task bar according to the first embodiment of the present invention.

FIG. 6 is a view schematically illustrating an example of a two-way operation using a cross border task bar according to a second embodiment of the present invention.

FIG. 7 is a view schematically illustrating an example of a two-way operation using the cross border task bar according to the second embodiment of the present invention.

FIG. 8 is a view schematically illustrating a configuration of a tablet terminal according to a third embodiment of the present invention.

### DETAILED DESCRIPTION OF THE INVENTION

Embodiments of an information processing device and an image display method according to the present invention will be described hereinafter with reference to the drawings.

### First Embodiment

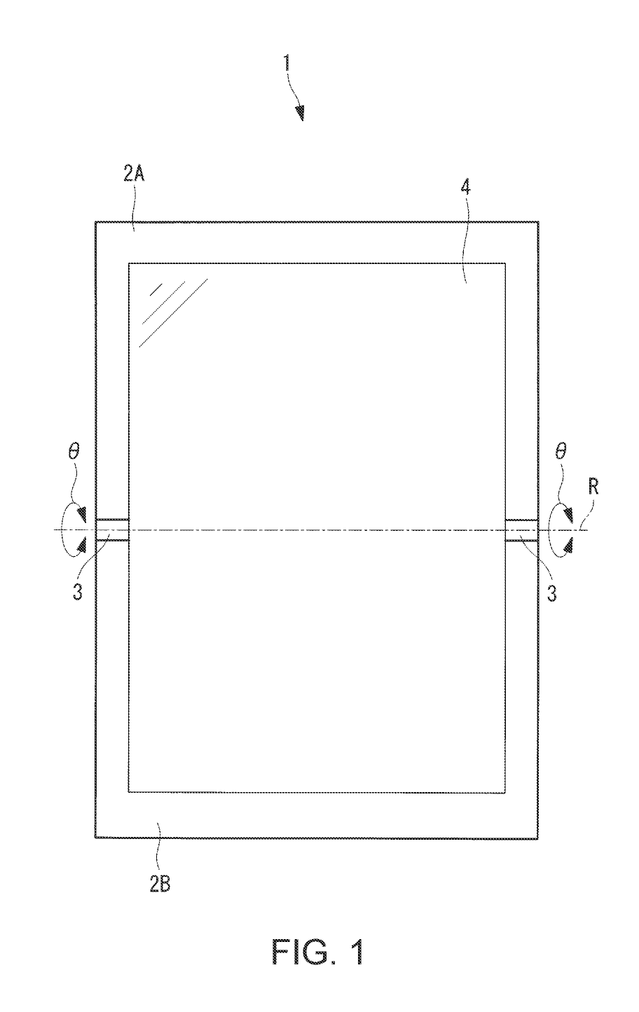

FIG. 1 is an outline view schematically illustrating a flexible display device 1 that is an information processing device according to a first embodiment.

The flexible display device 1 includes a flexible image display section 4. The image display section 4 is, for example, a touch panel.

The flexible display device 1 includes a first chassis 2A and a second chassis 2B. The first chassis 2A and the second chassis 2B are, for example, substantially rectangular.

The flexible display device 1 includes a hinge (connecting part) 3 rotatably connecting the first chassis 2A and the second chassis 2B to each other. An angle formed by the first chassis 2A and the second chassis 2B with respect to a rotational axis R is defined as “0.” The hinge 3 rotatably couples the first chassis 2A and the second chassis 2B in such a manner that each of the first chassis 2A and the second chassis 2B can rotate 360 degrees about the rotational axis R.

An image display section 4 is disposed on the first chassis 2A and the second chassis 2B in such a manner that a center line of the image display section 4 overlaps the rotational axis R. When the first chassis 2A and the second chassis 2B rotate about the rotational axis R, the flexible image display section 4 bends, while following the rotation.

The flexible display device 1 can be set in various modes by rotating the first chassis 2A and the second chassis 2B using the hinge 3. The state illustrated in FIG. 1 is a tablet mode in which θ=180° and the image display section 4 is flat.

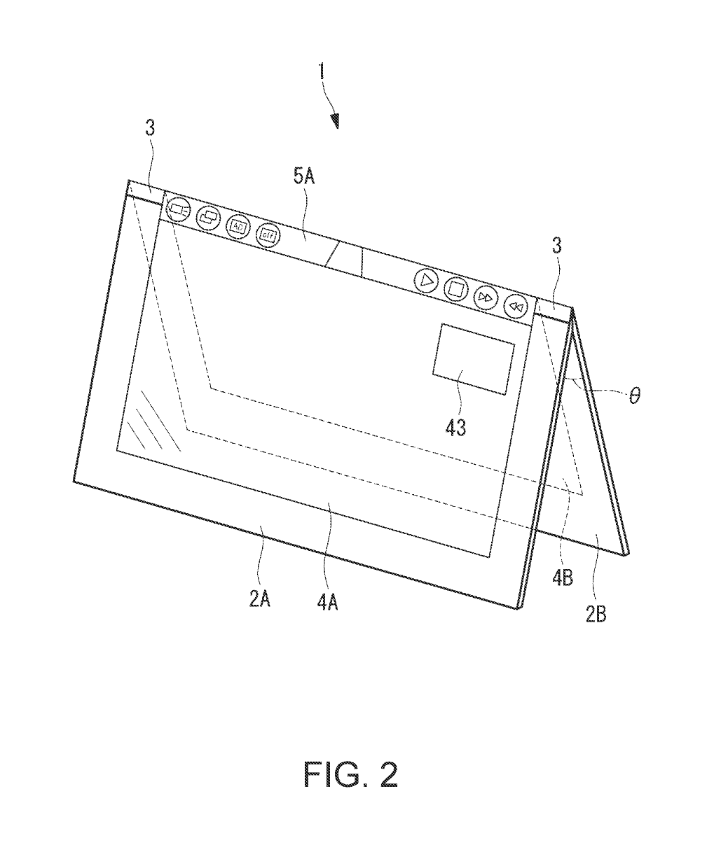

The state illustrated in FIG. 2 is a tent mode in which 180°<θ<360° and a first image display region 4A and a second image display region 4B are caused to face in different directions by rotation.

In addition to the tablet mode and the tent mode, modes of the flexible display device 1 include a closed mode, a clamshell mode, a basic mode, and a book mode, for example. The closed mode is a state in which θ=0° and the image display section 4 is folded, facing inward. The clamshell mode is a state in which 0°<θ<180°. The basic mode is a state in which θ=360° and the image display section 4 is folded, facing outward. The book mode is a state in which 0°<θ<180° and the rotational axis R is oriented in a substantially vertical direction with respect to a horizontal plane.

When the flexible display device 1 is in the tent mode, the image display section 4 is virtually divided into the first image display region 4A and the second image display region 4B using the rotational axis R as a division line. In the tent mode, the second image display region 4B displays an image in a vertically reversed orientation from an image displayed on the first image display region 4A so that the image displayed on the second image display region 4B can be correctly viewed.

Positions and sizes of the first image display region 4A and the second image display region 4B are previously determined, but the rotational axis R is not necessarily used as a division line as described above. The first image display region 4A and the second image display region 4B may have different sizes. In a case where the flexible display device 1 does not include the rotational axis R and can be freely bent, positions and sizes of the first image display region 4A and the second image display region 4B are not previously determined.

The tent mode is used for a presentation. For example, the first image display region 4A is disposed to face a presenter that is a user, and the second image display region 4B is disposed to face an audience. The presenter gives a presentation while displaying an object such as an image on the second image display region 4B facing the audience. It is however difficult for the presenter facing the first image display region 4A to visually recognize a display state of the second image display region 4B facing the audience. Thus, it is difficult for the presenter to confirm that an intended object is displayed on the second image display region 4B.

In view of this, the flexible display device 1 according to this embodiment displays a cross border task bar 5A on the first image display region 4A while being set in the tent mode. The cross border task bar is a graphical user interface for enabling the user to operate an object displayed on the second image display region 4B, which will be specifically described later.

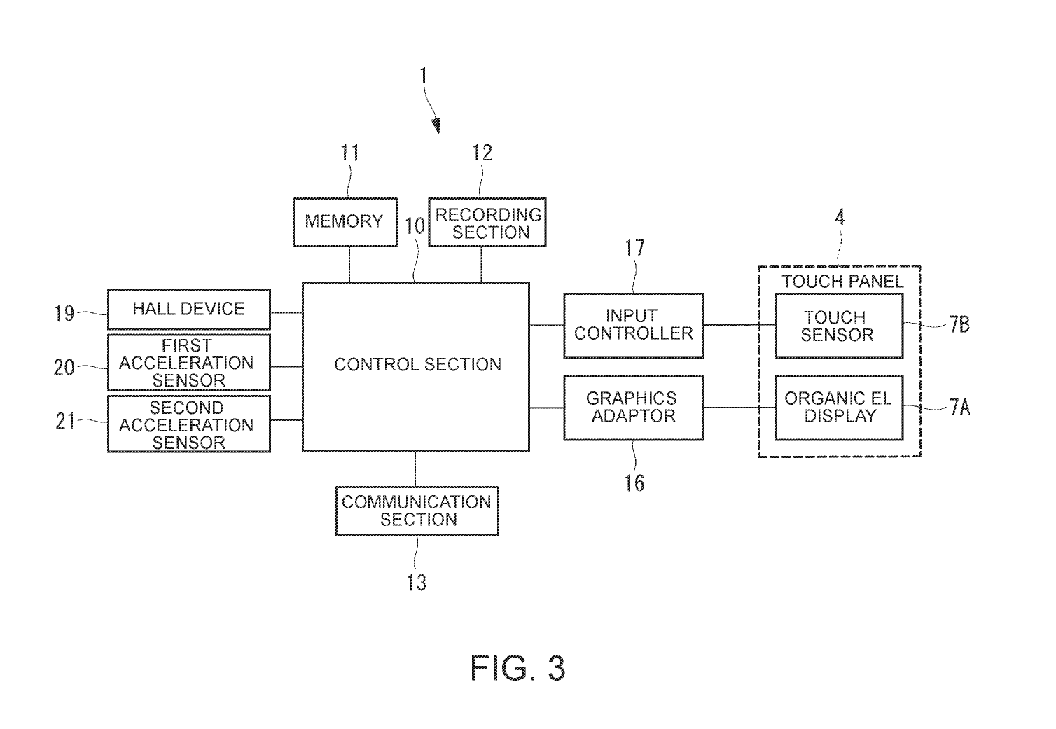

FIG. 3 is a functional block diagram illustrating an electrical configuration of the flexible display device 1.

The flexible display device 1 includes a control section 10, a memory 11, a recording section 12, a communication section 13, a graphics adaptor 16, an input controller 17, a Hall device 19, a first acceleration sensor 20, and a second acceleration sensor 21.

The control section 10 is, for example, a central processing unit (CPU), a microprocessor, or a digital signal processor (DSP), and implements various functions (modes) by centrally controlling operations of the flexible display device 1. Specifically, the control section 10 executes an instruction included in a program recorded in the recording section 12 with reference to data recorded in the recording section 12 and data developed to the memory 11 when necessary, and controls the image display section 4, which is a touch panel, and the communication section 13, thereby implementing various functions. Programs executed by the control section 10 and data referred to by the control section 10 may be downloaded from a server device with wireless communication by the communication section 13.

The memory 11 is, for example, a random access memory (RAM) or a dynamic random access memory (DRAM), and is used as a work area in which a program to be executed by the control section 10, data to be referred to by the control section 10, and computing results of control section 10, for example, are temporarily recorded.

The recording section 12 is, for example, a nonvolatile memory, and stores programs and data to be used for processing of the control section 10. Programs recorded in the recording section 12 include an operation system (OS) implementing basic functions of the flexible display device 1, a device driver for controlling hardware of the device, and a browser program for providing functions for implementing a web browsing function, for example.

The communication section 13 controls communication with other information processing devices through a network.

The image display section 4 that is a touch panel includes an organic electro-luminescence (EL) display 7A and a touch sensor 7B.

The organic EL display 7A displays an input video signal as an image.

The touch sensor 7B is, for example, a capacitance-type touch sensor, detects a touch position of a user on the organic EL display 7A, and outputs the detected position to the input controller 17. The touch sensor 7B selects a screen object such as one of various menus, icons, and buttons, or a keyboard displayed on the organic EL display 7A to perform an input operation, a text input operation, or a screen operation such as scroll or swipe.

The graphics adaptor 16 converts display information to a video signal and outputs the converted video signal to the organic EL display 7A, in accordance with control of the control section 10.

The input controller 17 performs various processes upon execution of a program recorded in, for example, the recording section 12 by the processor, and controls an operation of the touch sensor 7B.

The Hall device 19 is a bipolar Hall device, and is disposed in the first chassis 2A. The position of the Hall device 19 corresponds to a position of a magnet (not shown) that is disposed in the second chassis 2B. More specifically, in the closed mode and the basic mode of the flexible display device 1, the Hall device 19 and the magnet are disposed to face each other.

The Hall device 19 detects a magnetic field generated by the magnet in the second chassis 2B and outputs a detection result of the magnetic field to the control section 10.

The first acceleration sensor 20 detects acceleration degrees in a direction X₁ parallel to a longitudinal direction, a direction Y₁ parallel to a lateral direction, and a direction Z₁ perpendicular to the directions X₁ and Y₁, with respect to the first chassis 2A. The detected acceleration values Ax₁(t), Ay₁(t), and Az₁(t) in the directions X₁, Y₁, and Z₁ are output to the control section 10.

The second acceleration sensor 21 detects acceleration degrees in a direction X₂ parallel to a longitudinal direction, a direction Y₂ parallel to a lateral direction, and a direction Z₂ perpendicular to the directions X₂ and Y₂, with respect to the second chassis 2B. The detected acceleration values Ax₂(t), Ay₂(t), and Az₂(t) in the directions X₂, Y₂, and Z₂ are output to the control section 10.

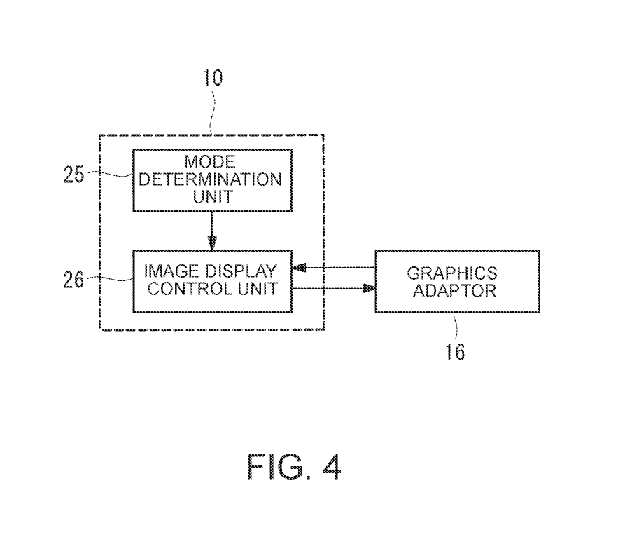

FIG. 4 is a functional block diagram concerning a screen display operating function.

The screen display operating function is a function of causing the cross border task bar 5A to be displayed on the first image display region 4A and enabling a user facing the first image display region 4A to operate an object displayed on the second image display region 4B.

The control section 10 includes a mode determination unit 25 and an image display control unit 26.

The mode determination unit 25 determines a current mode of the flexible display device 1. Specifically, the mode determination unit 25 determines a positional relationship between the first image display region 4A and the second image display region 4B. Based on the acceleration values Ax₁(t), Ay₁(t), and Az₁(t) output from the first acceleration sensor 20, the mode determination unit 25 determines an orientation of the first chassis 2A. Based on the acceleration values Ax₂(t), Ay₂(t), and Az₂(t) output from the second acceleration sensor 21, the mode determination unit 25 detects an orientation of the second chassis 2B. Then, based on the detected orientations of the first chassis 2A and the second chassis 2B, the mode determination unit 25 determines whether the current mode is the tablet mode, the tent mode, the book mode, or the clamshell mode.

Based on the detection result of the magnetic field of the Hall device 19, the mode determination unit 25 distinguishes the basic mode and the closed mode from each other.

In this manner, the first acceleration sensor 20, the second acceleration sensor 21, and the Hall device 19 serve as detection sections for detecting orientations of the first chassis 2A and the second chassis 2B, that is, orientations of the first image display region 4A and the second image display region 4B.

Then, the mode determination unit 25 determines a change of the mode indicating that the positional relationship between the first image display region 4A and the second image display region 4B changes to a predetermined positional relationship. The predetermined positional relationship is, for example, the tent mode.

In a case where the mode determination unit 25 determines that the current mode changes to the tent mode, the image display control unit 26 causes the first image display region 4A to display the cross border task bar 5A through the graphics adaptor 16. In a case where the mode determination unit 25 determines that the tent mode changes to another mode, the image display control unit 26 dismisses the cross border task bar 5A displayed on the first image display region 4A.

Then, the image display control unit 26 causes the second image display region 4B to display an object through the graphics adaptor 16, in accordance with an operation of a user on the cross border task bar 5A. The object is data as a target of an operation of the user, such as a still image, a moving image, audio data, a folder, or various types of other files, and is also referred to as contents.

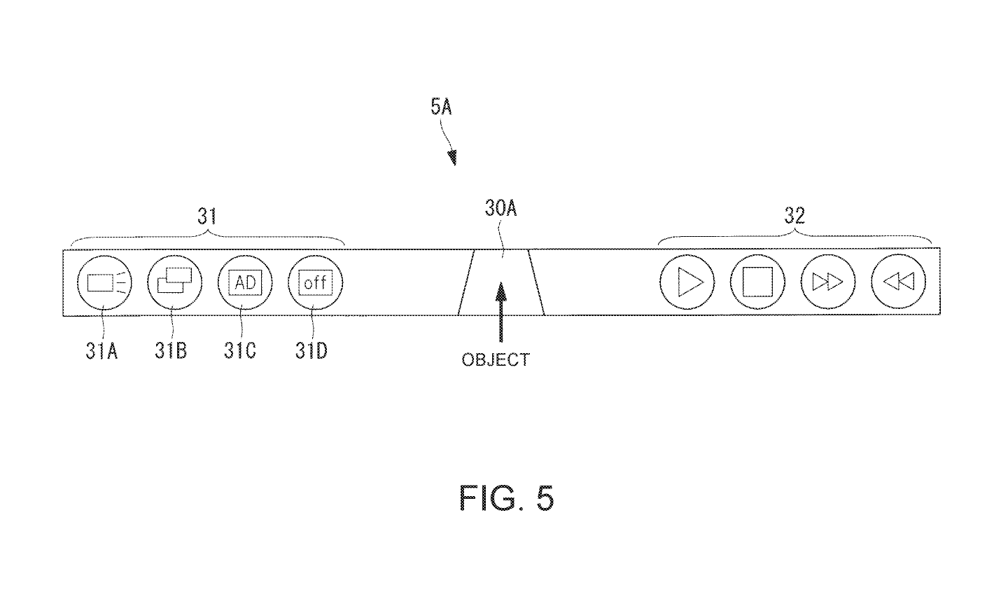

FIG. 5 is a view illustrating the cross border task bar 5A.

As also illustrated in FIG. 2, the cross border task bar 5A is displayed along an upper side of the first image display region 4A, for example. Alternatively, the cross border task bar 5A may also be displayed along a lower side, a left side, or a right side of the first image display region 4A. The cross border task bar 5A may be moved to a position by a user.

As illustrated in FIG. 2, when the cross border task bar 5A is displayed, the first image display region 4A displays a pop-up window 43 indicating a display state of the second image display region 4B.

The cross border task bar 5A includes a tunnel window 30A, a screen mode switching button 31, and a control button 32.

The tunnel window 30A is a drag region to which an object displayed on the first image display region 4A is dragged by a user. The object dragged to the tunnel window 30A is an icon indicating a still image or a moving image or a folder in which data is stored.

The object dragged to the tunnel window 30A is displayed on the second image display region 4B. Specifically, in a case where the dragged object is a still image or a moving image, this still image or moving image is displayed on the second image display region 4B. In a case where the dragged object is a folder, the folder is copied and the copy is displayed on the second image display region 4B together with data stored in this folder. The data stored in the folder displayed on the second image display region 4B can be freely opened by a user facing the second image display region 4B.

On the first image display region 4A, the object dragged to the tunnel window 30A returns to an original position before the drag.

The tunnel window 30A has a trapezoidal shape, for example. The present invention, however, is not limited to this example, and the shape only needs to be a shape with which a user can intuitively recognize that the object having this shape can be output to the second image display region 4B. The shape of the tunnel window 30A may be a shape narrowing toward the second image display region 4B, for example, and may be other shapes such as a triangle or an arrow shape.

The screen mode switching button 31 is a button for enabling a user to switch a screen mode of the second image display region 4B. The screen mode switching button 31 includes a presentation button 31A, a mirror button 31B, an advertising button 31C, and an off button 31D.

The presentation button 31A is a button for displaying an image for a presentation on the second image display region 4B. A screen mode in a case where the presentation button 31A is pressed is a presentation mode.

In the presentation mode, for example, when presentation software is activated, only an image to be used for a presentation (hereinafter referred to as a “presentation image”) is displayed on the second image display region 4B. On the other hand, the first image display region 4A displays another image necessary for a user who is a presenter, together with the presentation image displayed on the second image display region 4B.

In the presentation mode, when a still image is dragged to the tunnel window 30A, the dragged still image is displayed on the second image display region 4B. In the presentation mode, when a moving image is dragged to the tunnel window 30A, the dragged moving image is displayed on the second image display region 4B. In the presentation mode, when a folder storing a plurality of still images is dragged to the tunnel window 30A, the still images stored in the dragged folder are displayed by slide show on the second image display region 4B. An image dragged to the tunnel window 30A may be displayed as a pop-up window on the second image display region 4B.

The mirror button 31B is a button for displaying, on the second image display region 4B, an image identical to an image displayed on the first image display region 4A. A screen mode in a case where the mirror button 31B is pressed is a mirror mode.

In the mirror mode, for example, when a folder is dragged to the tunnel window 30A, the folder dragged to the second image display region 4B is copied and the copy is displayed. A user facing the second image display region 4B can freely view data stored in the folder displayed in the second image display region 4B.

In this manner, the image display control unit 26 provides different display states of an object dragged to the tunnel window 30A on the second image display region 4B, depending on the screen mode that changes by pressing the presentation button 31A or the mirror button 31B.

The advertising button 31C enables a predetermined object to be displayed on the second image display region 4B. A screen mode in a case where the advertising button 31C is pressed is an advertising display mode. The predetermined object is, for example, a still image or a moving image indicating a corporate advertising.

The off button 31D is a button for stopping an operation on the second image display region 4B. A screen mode in a case where the off button 31D is pressed is an off mode. When the off button 31D is pressed, no image or a predetermined image is displayed on the second image display region 4B, for example.

Even when the off button 31D is pressed, if an object is then dragged to the tunnel window 30A or the presentation button 31A or the mirror button 31B is then pressed, the mode is switched so that various types of objects are displayed on the second image display region 4B.

The control button 32 includes buttons for, for example, playback, stop, fast forward, and fast reverse of an object such as a moving image or audio data displayed on the second image display region 4B.

As described above, the flexible display device 1 according to this embodiment includes the first image display region 4A and the second image display region 4B for displaying an image. In a case where it is determined that the positional relationship between the first image display region 4A and the second image display region 4B changes to the tent mode, the cross border task bar 5A is displayed on the first image display region 4A.

Thus, the flexible display device 1 enables easy operation on an object displayed on a display region that is difficult to be visually recognized by a user.

### Second Embodiment

A second embodiment of the present invention will be described hereinafter.

A configuration of a flexible display device 1 according to the second embodiment is similar to that of the flexible display device 1 according to the first embodiment illustrated in FIGS. 1 through 4, and thus, description thereof will be omitted.

In this embodiment, a cross border task bar 5A is displayed on a first image display region 4A, and a cross border task bar 5B is displayed on a second image display region 4B. In this manner, the flexible display device 1 enables a two-way operation on the first image display region 4A and the second image display region 4B using the cross border task bars 5A and 5B.

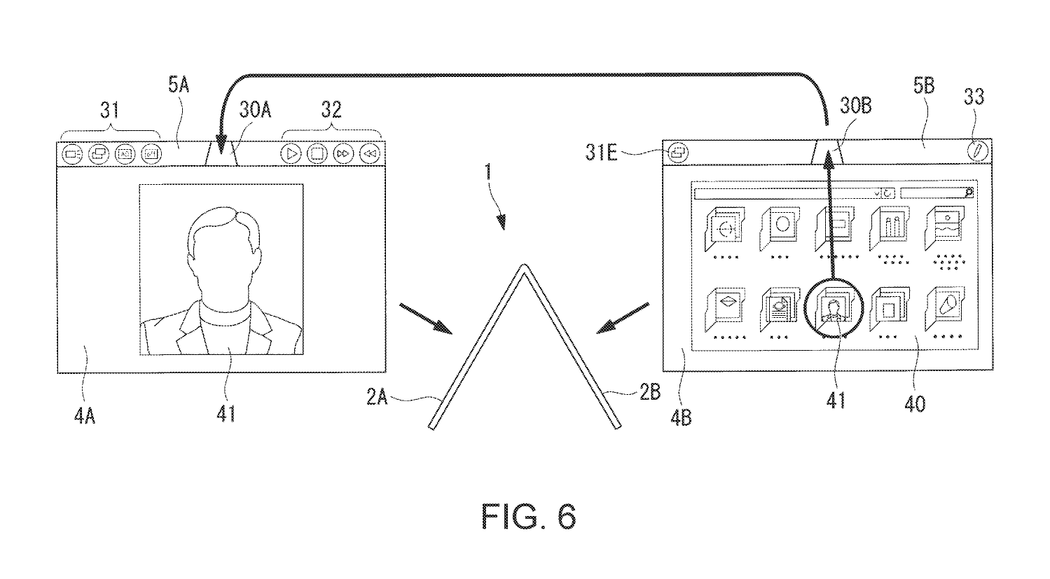

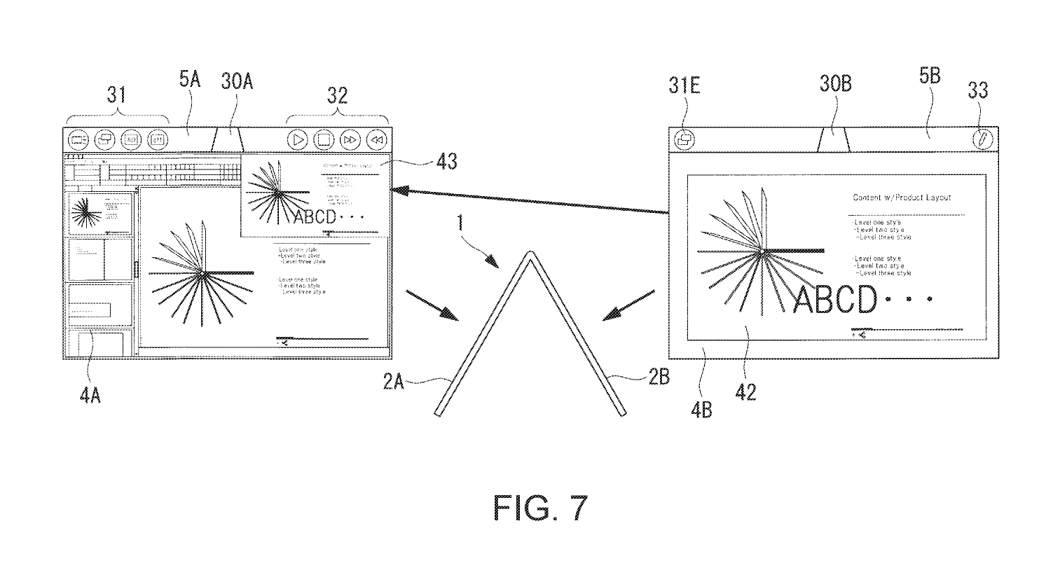

FIGS. 6 and 7 are views schematically illustrating examples of the two-way operation using the cross border task bar 5B displayed on the second image display region 4B. In FIGS. 6 and 7, the first image display region 4A faces a presenter, and the second image display region 4B faces an audience.

The cross border task bar 5B includes a tunnel window 30B, a mirror button 31E, and a pen button 33. In this manner, as an example, the cross border task bar 5B has a limited function as compared to the cross border task bar 5A.

The pen button 33 is a button for writing on an image displayed on the second image display region 4B. A user presses the pen button 33 and then touches the second image display region 4B with an indicator such as a finger so that the user can perform writing on the displayed image.

The mirror button 31E is a button for displaying the image subjected to the writing on the first image display region 4A.

FIG. 6 illustrates a state in which a folder 40 is dragged from the first image display region 4A to the second image display region 4B through the tunnel window 30A and the folder 40 is opened. The folder 40 stores a plurality of objects. More specifically, when the mirror button 31B of the cross border task bar 5A is pressed to set a mirror mode and the folder 40 is dragged to the tunnel window 30A, the folder 40 is displayed on the second image display region 4B.

The user facing the second image display region 4B drags an object 41 stored in the folder 40 to the tunnel window 30B. In this manner, the first image display region 4A displays the contents of the object 41. In the example illustrated in FIG. 6, the folder 40 stores a plurality of still images, and when the folder 40 is dragged to the tunnel window 30B, the still images are displayed by slide show on the first image display region 4A.

FIG. 7 illustrates a case where writing is performed on an image displayed on the second image display region 4B using the pen button 33. In the example illustrated in FIG. 7, the presentation button 31A of the cross border task bar 5A is pressed and a presentation image 42 is displayed on the second image display region 4B.

The user who is an audience presses the pen button to perform writing such as “ABCD . . . ” on the presentation image 42 displayed on the second image display region 4B. Thereafter, when the user presses the mirror button 31E so that the presentation image 42 subjected to the writing is displayed in a pop-up window 43 on the first image display region 4A.

### Third Embodiment

A third embodiment of the present invention will be described hereinafter.

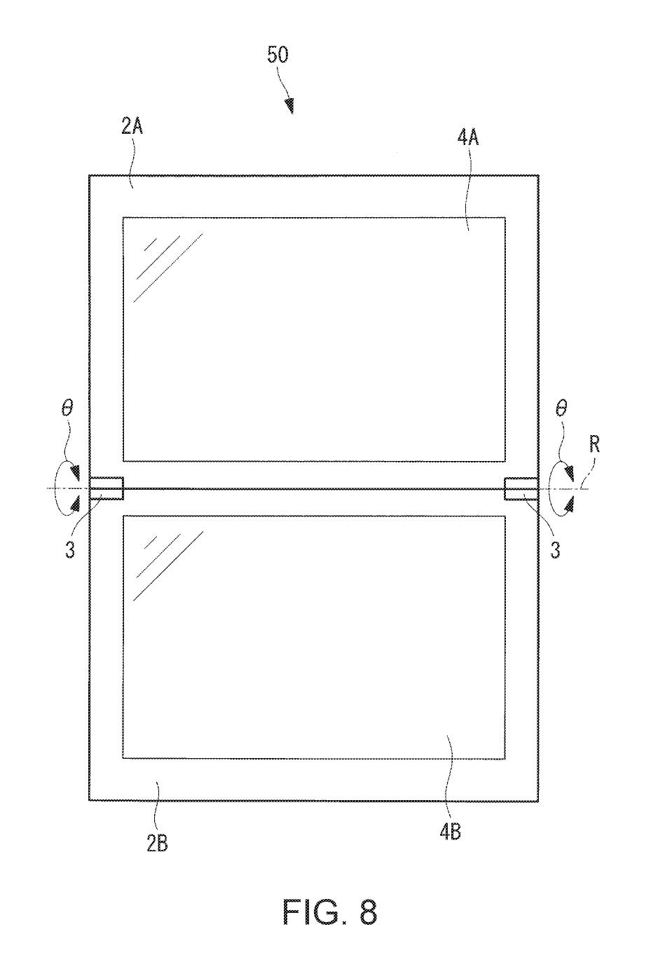

FIG. 8 illustrates a configuration of a tablet terminal 50 that is an information processing device according to the third embodiment. Components of the configuration illustrated in FIG. 8 already described with reference to FIG. 1 are denoted by the same reference numerals, and description thereof will be omitted.

The tablet terminal 50 includes a first chassis 2A and a second chassis 2B each including an image display section 4. The image display section 4 of the first chassis 2A will be hereinafter referred to as a first image display region 4A, and the image display section 4 of the second chassis 2B will be hereinafter referred to as a second image display region 4B.

In the tablet terminal 50, in a case where it is determined that the screen mode is in a tent mode, a cross border task bar 5A is displayed on the first image display region 4A. In the case where it is determined that the screen mode is in the tent mode, a cross border task bar 5B may be displayed on the second image display region 4B.

In the tablet terminal 50, the first chassis 2A and the second chassis 2B may be separated from each other. The separated first chassis 2A and second chassis 2B can transmit and receive data to/from each other wirelessly or with wires.

In a case where the first chassis 2A and the second chassis 2B are separated from each other as a predetermined positional relationship between the first image display region 4A and the second image display region 4B, the cross border task bar 5A is displayed on the first image display region 4A. In the case where the first chassis 2A and the second chassis 2B are separated from each other, the cross border task bar 5B may be displayed on the second image display region 4B.

The present invention has been described with reference to the embodiments. The technical scope of the present invention, however, is not limited to the range described in the above embodiments. Various changes and modifications may be made on the embodiments within the range of the invention, and embodiments obtained by such changes and modifications are included in the technical scope of the invention. The embodiments may be suitably combined.

For example, in the embodiments described above, the cross border task bar 5A includes the tunnel window 30A, the screen mode switching button 31, and the control button 32. The present invention, however, is not limited to this example. The cross border task bar 5A may include a button having a function different from those of the buttons described above, or may include one or more of those buttons.

In the first and second embodiments, in the tent mode, the image display control unit 26 causes the cross border task bar 5A to be displayed on the first image display region 4A. The present invention, however, is not limited to this example. For example, in other modes except the tent mode, such as the basic mode, the image display control unit 26 may cause the cross border task bar 5A to be displayed on the first image display region 4A in accordance with an operation of a user. When an operation for displaying the cross border task bar 5A is performed by the user, the image display section 4 is virtually divided into the first image display region 4A and the second image display region 4B, in accordance with this operation.

We claim:

1. An information processing device comprising:
a first image display region;
a second image display region;
a determination unit configured to determine when an actual positional relationship between the first image display region and the second image display region changes to a predetermined positional relationship; and
an image display control unit that displays, on the first image display region, a graphical user interface that enables a user to operate on an object displayed on the second image display region, wherein the determination unit is configured to determine when the actual positional relationship between the first image display region and the second image display region changes to the predetermined positional relationship.

2. The information processing device according to claim 1, wherein:
the graphical user interface comprises a drag region to which an object displayed on the first image display region is dragged, and
the object dragged to the drag region is displayed on the second image display region.

3. The information processing device according to claim 2, wherein:
the graphical user interface comprises a presentation button, when pressed, displays an image for presentation on the second image display region, and a mirror button, when pressed, displays on the second image display region, an object identical to the object displayed on the first image display region.

4. The information processing device according to claim 3, wherein:
the information processing device comprises a screen mode that changes when the presentation button or the mirror button is pressed, and
the image display control unit is configured to display different states of an object dragged to the drag region in the second image display region, while dependent on the screen mode.

5. The information processing device according to claim 1, wherein:
the graphical user interface comprises an operation button that enables a user to operate a moving image displayed on the second image display region.

6. The information processing device according to claim 1, wherein:
the graphical user interface comprises an advertising button for displaying a predetermined object on the second image display region.

7. The information processing device according to claim 1, wherein:
the graphical user interface is displayed on both the first image display region and the second image display region.

8. The information processing device according to claim 7, wherein:
the graphical user interface displayed on the second image display region comprises a drag region to which an object displayed on the second image display region is dragged, and
the object dragged to the drag region is displayed on the first image display region.

9. The information processing device according to claim 7, wherein:
the graphical user interface displayed on the second image display region comprises a button configured to enable writing on an image displayed on the second image display region and a button, when pressed, to display the image with the writing on the first image display region.

10. The information processing device according to claim 1, wherein:
a pop-up window on the first image display region is configured to display a state of the second image display region.

11. The information processing device according to claim 1, further comprising:
a first chassis comprising the first image display region;
a second chassis comprising the second image display region; and
a connecting part configured to rotatably connect the first chassis and the second chassis to each other.

12. The information processing device according to claim 11, wherein:
the graphical user interface is displayed on the first image display region when the first image display region and the second image display region are rotated to face different directions.

13. The information processing device according to claim 11, wherein:
the first chassis and the second chassis are configured to be separable from each other.

14. The information processing device according to claim 13, wherein:
when the first chassis and the second chassis are separated from each other, the graphical user interface is displayed on the first image display region.

15. An image display method of an information processing device including a first image display region and a second image display region, the method comprising:
determining when an actual positional relationship between the first image display region and the second image display region changes to a predetermined positional relationship; and
displaying, on the first image display region, a graphical user interface that enables a user to operate on an object displayed on the second image display region, when it is determined that the actual positional relationship between the first image display region and the second image display region changes to the predetermined positional relationship.

16. A program configured to enable a computer provided in an information processing device that includes a first image display region and a second image display region to function as:
a determination unit that determines when an actual positional relationship between the first image display region and the second image display region changes to a predetermined positional relationship; and
an image display control unit that displays, on the first image display region, a graphical user interface for enabling a user to operate on an object displayed on the second image display region, when the determination unit determines that the actual positional relationship between the first image display region and the second image display region changes to the predetermined positional relationship.
